(19) United States
(12) Patent Application Publication
(10) Pub. No.: US 2016/0314397 A1
(43) Pub. Date: Oct. 27, 2016

(54) Attitude Detection

(71) Applicant: International Business Machines Corporation, Armonk, NY (US)

(72) Inventors: Geli Fei, Chicago, IL (US); Jalal U. Mahmud, San Jose, CA (US); Aditya Pal, San Jose, CA (US); Michelle X. Zhou, Saratoga, CA (US)

(73) Assignee: INTERNATIONAL BUSINESS MACHINES CORPORATION, Armonk, NY (US)

(21) Appl. No.: 14/693,046

(22) Filed: Apr. 22, 2015

(51) Int. Cl. G06N 5/04; G06N 99/00

(52) U.S. Cl. CPC G06N 5/04; G06N 99/005

(57) ABSTRACT

Embodiments relate to detecting an attitude of a user towards a target prior to or without presence of a direct expression of the attitude. A dictionary is built with a first collection of positive attitude content and a second collection of negative attitude content. In addition, a statistical model of attitude relevance is constructed based on content based similarity metrics. The model utilizes the dictionary and statistically assesses attitude relevance. Based on the assessment the user is classified as relevant or non-relevant for attitude towards the target.

### BACKGROUND

The present embodiment(s) relates to identifying a potential attitude towards a target. More specifically, the embodiment(s) relates to construction of an attitude dictionary and associated model for classifying an attitude of an expression.

Social media is a collection of on-line communications channels dedicated to community based input, interaction, content sharing, and collaboration. Different types of social media include, but are not limited to, web sites, applications dedicated to forums, microblogging, and social networking. It has become common for products and associated brands to have social media present to attract potential customers.

As social media expands, there is a challenge associated with managing the vast quantity of information and data that is present in these channels. Social media is being used for product marketing to develop a presence and popularity of a product among potential customers. More specifically, social media is used to recruit and develop an attitude of potential customers. Attitude is a way of thinking or feeling about someone or something, and is typically reflected in behavior. A key step to understanding attitude in the digital world of social media is to detect attitude towards a target. With respect to on-line attitude and social media, existing approaches check for a target site keyword in electronic communications. These approaches are directed to a specific keyword and identify users when such keywords are explicitly mentioned, but do not address or identify users who do not have an explicit use of the keyword(s). Accordingly, existing solutions for attitude detection are narrowly defined and do not include identification of potential attitude.

### SUMMARY

The embodiment(s) include a method, computer program product, and system for attitude detection.

The method, computer program product, and system are employed to detect attitude prior to or without a direction expression of the attitude. The attitude dictionary is constructed. In one embodiment, a separate dictionary is constructed for different targets. The dictionary mines keywords from content of social media posts, and identifies an expression of relevance. The dictionary is stored at a first memory location. A statistical model of attitude relevance towards each target is built. In one embodiment, a separate model is built for each target. The dictionary generates features for the model. The model is stored at a second memory location. Prior to receipt of a direct expression to a target, a communication from a source is compared to the model, and an attitude classification for the source is created. The comparison converts an identity of the source to the attitude classification.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments, and not of all embodiments unless otherwise explicitly indicated.

FIG. 1 depicts a flow chart illustrating a process for constructing an attitude dictionary for detecting potential attitude.

FIG. 2 depicts a flow chart illustrating a process for constructing a relevance dictionary.

FIG. 3 depicts a flow chart illustrating a process for computing relevance and assessing the strength of the computation.

FIG. 4 depicts a flow chart illustrating a process for detecting an attitude of a user to a target through use of the attitude dictionary and the built statistical model.

FIG. 5 depicts a block diagram illustrating hardware components of a system for attitude detection.

FIG. 6 depicts a block diagram of a computer system and associated components for implementing an embodiment.

### DETAILED DESCRIPTION

It will be readily understood that the components of the present embodiment(s), as generally described and illustrated in the Figures herein, may be arranged and designed in a wide variety of different configurations. Thus, the following detailed description of the embodiments of the apparatus, system, and method, as presented in the Figures, is not intended to limit the scope, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiment(s) as claimed herein.

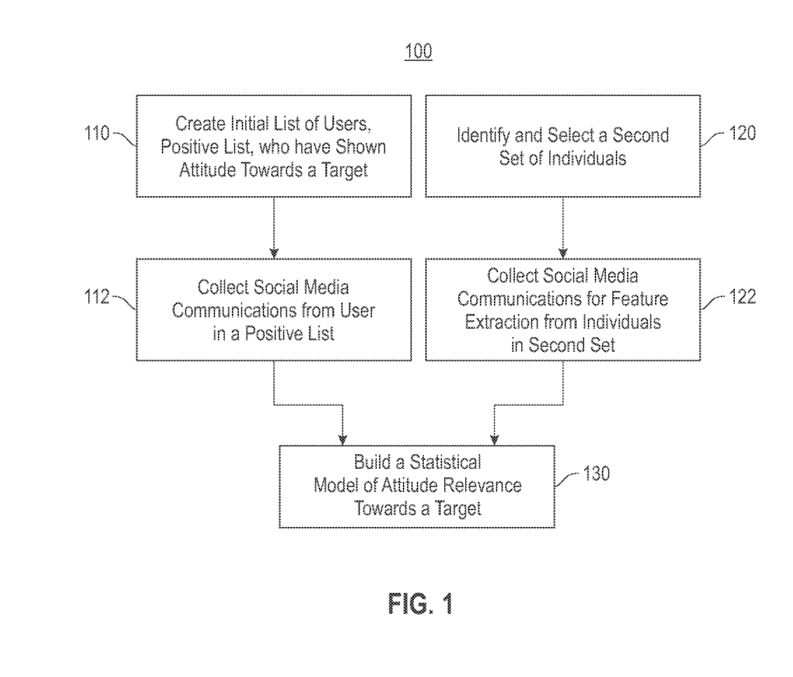

Identification of attitude and presence in digital media, also referred to as online presence, is expanded to detect and identify potential attitude. More specifically, this identification detects attitude before or without a direct expression. A machine learning model is utilized to assess a pattern and to output a probability of attitude based on the pattern. With reference to FIG. 1, a flow chart (100) is provided illustrating a process for constructing an attitude dictionary for detecting potential attitude. An initial list is created from one or more users, also referred to as individuals, who have been determined and identified as having an attitude to a target (110). This list can be created manually or automated through a set of rules. In one embodiment, one or more keywords in an incoming social media stream are used to identify users in this initial list. Each user that is identified in the list is referred to and treated as an example of a positive attitude with respect to building a statistical model. Accordingly, the initial aspect of identifying potential attitude is to create a list of users who have exhibited some form of positive attitude or interest.

Once a set of individuals have been identified, their social media communications are collected (112). Social media is defined as forms of electronic communication through which users create online communities to share information, ideas, personal messages, and other content. The electronic communication includes, but is not limited to, website for social networking and microblogging. Social media is a collective of online communication entities and channels dedicated to community based input, interaction, content-sharing, and collaboration. Websites and applications dedicated to various entities and channels, including but not limited to, social networks, blogs, and forums, that solicit input and feedback are among the different types of social media. Data gathered by these entities and channels are referred to as social media data.

As described in detail below, the collection of social media communications (112) are referred to as a positive set of communications. To ensure that the potential attitude is comprehensive, a second set of individuals are identified and selected (120). In one embodiment, the individuals in the second set are selected at random. Similarly, in one embodiment, the individuals in the second set are any individuals who have not expressly shown an interest or attitude in the target. Social media communications are collected for feature extraction from the individuals in the second set (122). In one embodiment, the individuals that are members of the second list, and specifically their communications, are treated as examples of negative attitude with respect to the statistical model. With identification of positive and negative communication attitude, a statistical model of attitude relevance towards a target is built (130). Features for the statistical model of attitude are based on content similarity metrics, social media usage, textual content, etc. Once the model is created, a new user or recently identified user can be classified. More specifically, the model assesses the attitude of the recently identified user to the target, with the attitude identification being relevant or non-relevant to the target. In one embodiment, a recently identified individual determined to be relevant may have their attitude further assessed with respect to attitude favorability, persistence, resistance, etc. Similarly, the model may also output a probability or likelihood value associated with the assessed relevance. With this value, the recently identified user may be ranked with respect to other users in terms of their attitude towards the target. Accordingly, once created, the model is employed as an assessment tool with respect to individuals that are not members that comprise the model.

Once created, the attitude dictionary may be static or dynamic. In the case of a static dictionary, the construction takes place and the entries in the dictionary remain and new entries are not processed or accepted. The dynamic dictionary works on an inverse principal of the static form in that the dynamic dictionary can be updated based on model correction feedback or new examples. The dictionary is stored in a first memory location. Examples of the location include, but are not limited to, cache memory, a database table, persistent storage, etc. In the aspect of a dynamic dictionary, changes to the dictionary are written to the first memory location storing the dictionary. Accordingly, once created, the dictionary is stored in a specific location so that any changes may be applied, and the table may be accessed.

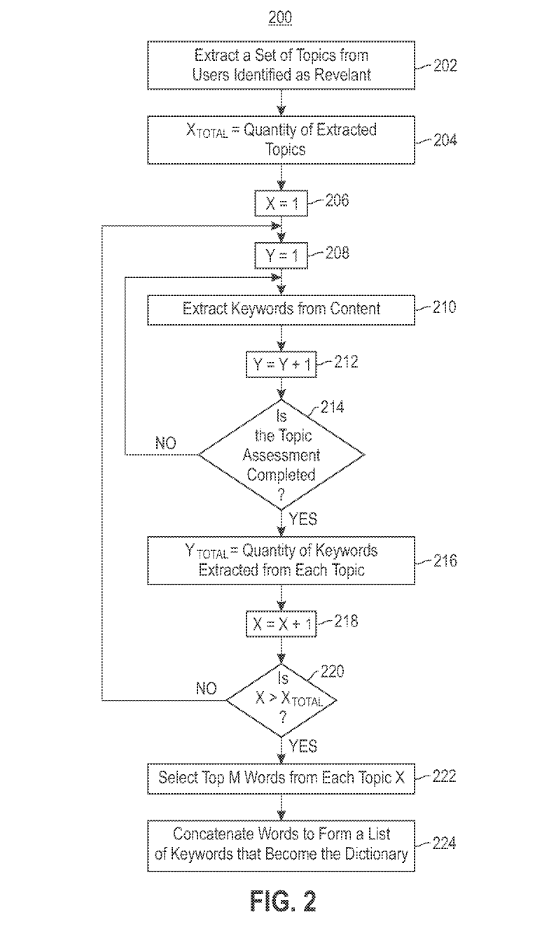

As shown in FIG. 1, two groups are established, with one group identifying users who have expressed an interest to particular social media content, and another group identifying users who have not expressed this interest. Once a user has been identified with an expressed interest, the basis for this interest may be explored in detail. Referring to FIG. 2, a flow chart (200) is provided illustrating a process for constructing a relevance dictionary. This relevance dictionary is used to compute similarity features. In one embodiment, the dictionary construction is automated. A set of keywords are mined from content of social media associated with one or more users who have been identified as relevant individual(s) with respect to the social media. Different techniques may be employed for the mining. A topic modeling technique extracts a set of topics from historical text content from users identified as relevant (202). The variable X_{Total} is assigned to the quantity of extracted topics (204), and an associated counting variable, X, is initialized (206). At the same time, for each topic, a keyword counting variable, Y, is initialized (208). As topic_{X} is applied to social media content accessed by the relevant users (208), one or more words associated with the content are extracted as keywords. More specifically, a keyword is extracted from the content (210), and the keyword counting variable for the topic is incremented (212). In one embodiment, two or more keywords may be extracted at step (210), with the keyword counting variable incremented for each extracted keyword. Until such time as the topic assessment is completed (214), the process returns to step (210) to continue extraction of keyword. However, when the topic assessment is completed, the variable Y_{Total} is assigned to the quantity of keywords extracted from each topic (216). Accordingly, one or more keywords are extracted from relevant content on the granularity level of the topics being assessed.

Following step (216), the topic counting variable, X, is incremented (218) and it is determined if all of the topics have been reviewed (220). A negative response to the determination at step (220) is followed by a return to step (208). However, a positive response is an indication that the keyword extraction aspect of the dictionary construction is completed. Following keyword extraction, the top M words from each topic X are selected (222) and concatenated to form a list of keywords that become the dictionary (224). In one embodiment, the list at step (224) is hierarchical and sorted based on strength of each word within the list. Accordingly, the dictionary is created from an assessment of a plurality of topics and identified keywords.

Based on the dictionary and the identified keywords, attitude relevance may be computed with respect to any arbitrary electronic communication. There are different computation techniques and associated scores to assess the strength of the attitude, with the computation value being an indicator of strength.

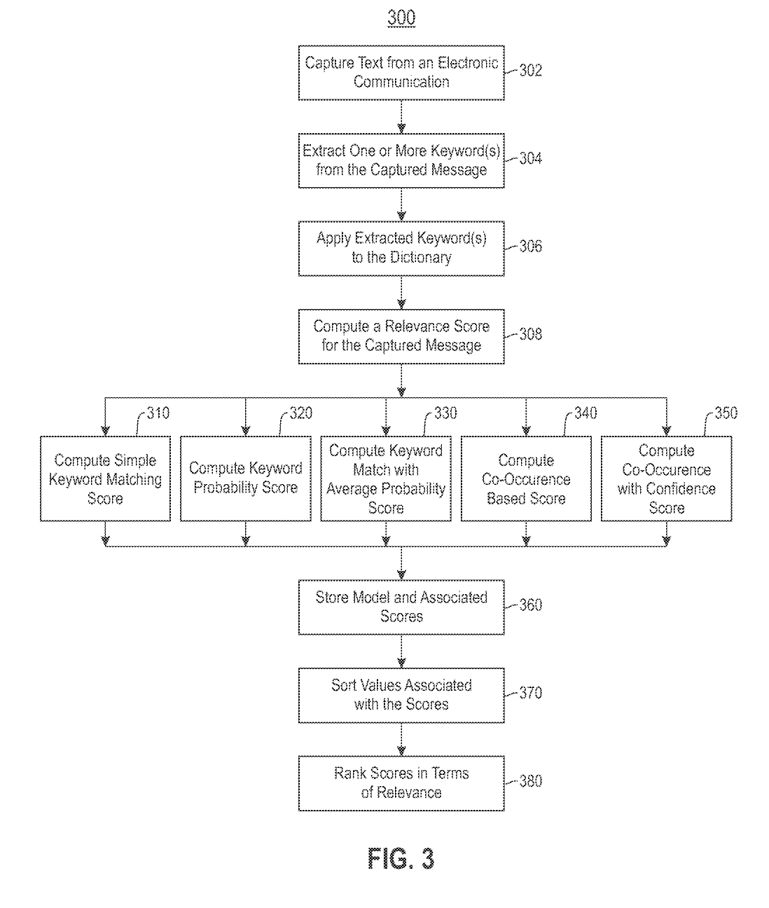

Referring to FIG. 3, a flow chart (300) is provided illustrating a process for computing attitude relevance and assessing the strength of the computation. Text from an electronic communication is captured (302). Texts may come in various forms, including but not limited to, an electronic mail message, a post on a blog, a tweet, a post on social media, etc. One or more words are extracted from the captured message (304), and the extracted keyword(s) are applied to the dictionary (306). A relevance score is computed for the captured message based on the application to the dictionary (308). Various scores may be computed, including a simple keyword matching score (310), a keyword probability score (320), a keyword match with average probability score (330), a co-occurrence based score (340), and a co-occurrence with confidence score (350). These scores should not be considered limiting, and in one embodiment, additional or alternative scores may be assessed. The scores comprise a statistical model of attitude relevance. The model and the associated scores are stored at a second memory location (360). Examples of the second memory location include, but are not limited to, cache memory, a database table, persistent storage, etc. Accordingly, the score(s) functions as an assessed numerical value with probability of relevance of a user that is the source of the captured communication.

The simple keyword matching score(s) (310) is an assessment that captures the strength of the captured communication based on matching one or more keywords as identified in the dictionary. The matching score is computed for a specific communication. More specifically, the score assesses if the match is within the maximum range, average range, or below average range. As shown and described in FIG. 2, the keyword(s) may be sorted within the hierarchy with words closer to the root, e.g. top, representing great strength and/or value. With the score assessed at step (310), a match with the keyword with a particular placement in the sorted list may be an indicator of strength.

Each keyword in the attitude dictionary is associated with a probability obtained from topic modeling. The keyword with probability score (320) uses the probability score in computing a keyword matching feature. When there is a keyword matching in the obtained communication, the probability of the keyword is used as a score. Thereafter, an overall matching score is obtained for the communication as a sum of all such scores normalized by a length of the communication.

The keyword match with average probability score (330) looks for a match of the top K keywords from each topic in the dictionary. As shown and described in FIG. 2, the counting variable X refers to the topics being assessed, and the variable Y refers the keyword(s) identified on a per topic basis. This score averages the probability value of the matched keywords, and returns the value as a score for each communication being assessed.

The co-occurrence score (340) represents the value of searches for co-occurrence of keywords in the communication being assessed. The number of co-occurrences is counted in each message, and normalized by pairs of words in each message. This normalized value for each communication is the co-occurrence confidence score (350), also referred to herein as the confidence score. The co-occurrence with confidence score (350) employs a confidence of co-occurrence in place of an actual count. The confidence is computed for each pair of keywords <wᵢ, wⱼ> in a topic. In one embodiment, the following formula is employed to assess a value on the confidence:

½*(d(wᵢ,wⱼ)/d(wᵢ)+d(wᵢ,wⱼ)/d(wⱼ)),

where d(wᵢ,wⱼ) is the co-document frequency of word wᵢ and wⱼ, d(wᵢ) is the document frequency of word wᵢ, and d(wⱼ) is the document frequency of word wⱼ. Thus, for computing keyword co-occurrence matching score of a tweet, for example, the confidence of co-occurrence for each matching pair of keywords is added and then normalized by the pairs of words in that tweet. In one embodiment, an alternative form of communication may be employed for the assessment of confidence of co-occurrence, and as such, should not be limited to a tweet.

The scores assessed in FIG. 3 are employed to assess if a captured communication is relevant. One or more keywords from the message are identified and scored with respect to a target. More specifically, the score enables the user or individual associated with the evaluated communication as relevant or non-relevant. The scores quantify the relevance. In one embodiment, the values associated with the scores are sorted (370) and ranked (380) in terms of relevance.

The set of scores, including co-occurrence, probability, matching, etc. are computed using the relevance dictionary and function as an attitude model. In one embodiment, this model is built from the assessed scores. The computations shown at steps (310)-(350) may be fully automated. In one embodiment, these features may include temporal activity and associated features.

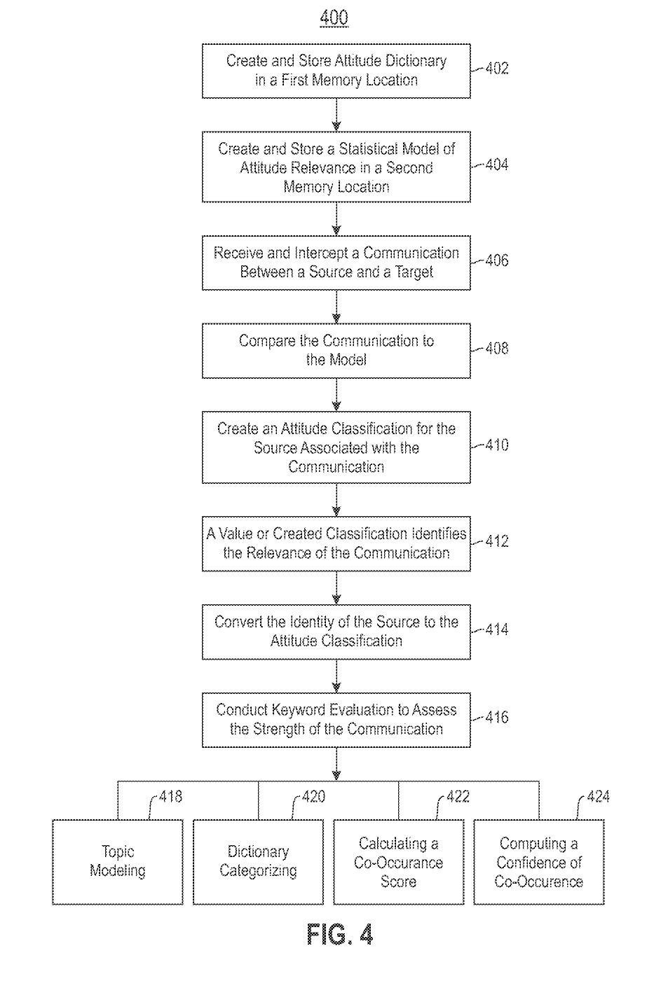

Referring to FIG. 4, a flow chart (400) is provided illustrating a process for detecting an attitude of a user to a target through use of the attitude dictionary and the built statistical model. As shown, the attitude dictionary has been created and stored in a first memory location (402). Details of the dictionary are shown and described in FIG. 1. In one embodiment, the dictionary is dynamic, and any changes and/or updates to the dictionary are written to the first memory location. In addition, the statistical model of attitude relevance has been created and stored in a second memory location (404). Details of the model are shown and described in FIGS. 2 and 3. In one embodiment, the model is periodically changed based on changes to the dictionary, with the changes created and stored in the second memory location. A communication between a source and a target is received or intercepted (406). In one embodiment, the source is associated with a communication and the target is the intended recipient or receiver of the communication. The communication is compared to the model (408), and an attitude classification is created for the source associated with the communication (410). In one embodiment, a score is assigned to the communication. A value or created classification identifies the relevance of the communication (412). Accordingly, the dictionary and model function to classify a received or intercepted communication with respect to relevance towards the intended target.

Each communication and/or the associated source have an identity associated with the target. Examples of the identity include, but are not limited to, positive, negative, and neutral. For example, a randomly generated communication may be neutral. A communication that is in reference to an ongoing business transaction may be positive since channels of communication may have been previously established. Regardless of the original identity, the new identify classifies the communication, and the identity of the source is converted to the attitude classification (414). In one embodiment, the source is identified as relevant or irrelevant, and the identity is converted to one of these classes. Accordingly, the attitude classification of the communication takes place without evaluation of any direction expression within the content of the communication.

Once the attitude has been associated with the source, keyword evaluation may be conducted to assess the strength of the communication (416). More specifically, the assessment at step (416) includes delving into the content of the communication, identifying one or more keywords in the communication, finding the keyword(s) in the dictionary and the strength value assigned to the keyword(s). Various forms of content evaluation may be conducted, including topic modeling (418), dictionary categorizing (420), calculating a co-occurrence score (422), and/or computing a confidence of co-occurrence (424). The topic modeling (418) includes modeling one or more topics of the identified keyword(s) and associating each keyword in the dictionary with a probability value as obtained from the topic modeling. In addition, a matching score for the communication is computed as a sum of all probability scores normalized by a length of the associated message. Categorizing the dictionary (420) includes categorizing by topics and identifying one or more keywords for each topic, and further includes searching for a match with one of the identified keywords from each topic and averaging a probability value of the matched keyword. Calculation of the co-occurrence score (422) includes counting a quantity of co-occurrences of keywords in a message and normalizing the quantity of pairs of keywords in the message. In addition to the co-occurrence score, a confidence of the co-occurrence may be computed (424) for each pair of keywords in a topic. Accordingly, once attitude has been detected, further evaluation of the communication may be conducted to assess strength of the communication via keyword evaluation and assessment.

As shown and described in FIGS. 1-4, an attitude relevance dictionary is constructed from content of social media. The dictionary may be static or dynamic. In the dynamic form, the dictionary changes as new content is received or changes based on new examples and/or model construction feedback. An attitude relevance model is built from a set of computed features using the dictionary. In one embodiment, the feature computation is fully automated. In another embodiment, the feature space may also include temporal activity based features, personality features, attitude relevance towards a different target, etc.

One of the goals of creation, maintenance, and utilization of the attitude dictionary is to assess relevance of communications, and more specifically to detect potential attitude for a communication. More specifically, the attitude detection takes place without any direct expression or relevance in the communication. The attitude detection takes place without use or detection of a keyword in a communication, where the keyword is a form of direct expression. Accordingly, the attitude detection tools and associated process(es) performs the evaluation with an indirect expression.

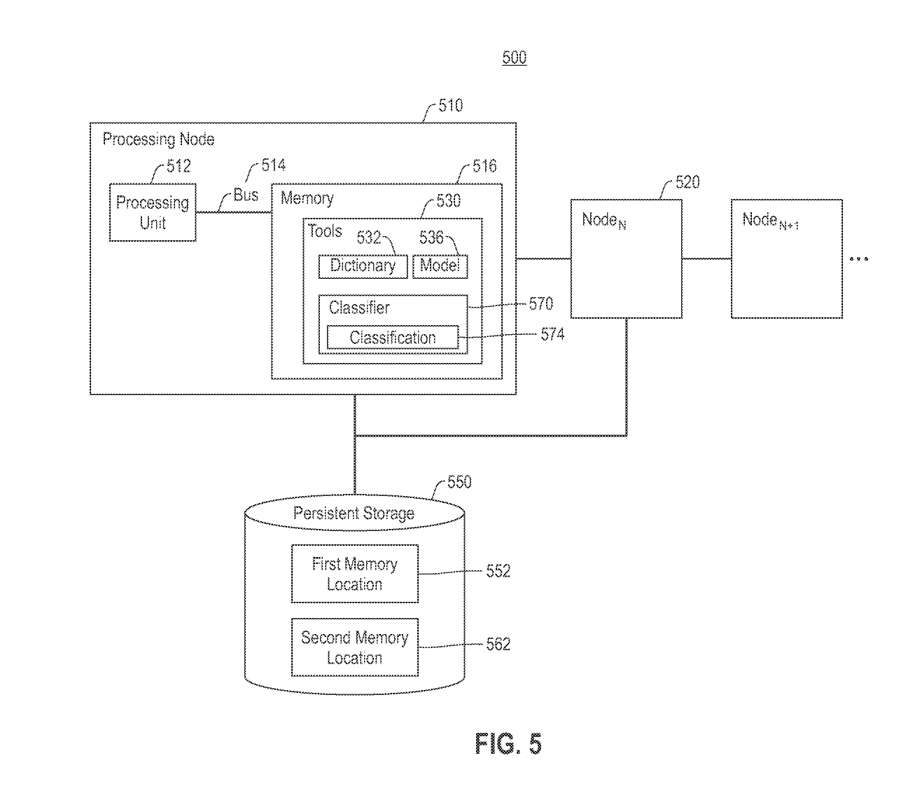

Referring to FIG. 5, a block diagram (500) is provided illustrating hardware components of a system for attitude detection. As shown, a processing node (510) is provided with a processor (512), also referred to herein as a processing unit, operatively coupled to memory (516) across a bus (514). The processing node (510) is further provided in communication with other nodes (520), which are in communication with persistent storage (550). In one embodiment, the persistent storage (550) is maintained in a data center accessible by both node (510) and the other processing nodes (520).

The attitude evaluation of communications employs tools in the form of a dictionary (532), a model (536), and a classifier (570). As shown herein, the tools are local to memory (516), although in one embodiment may be located in communication with the memory (516). Together, the tools perform evaluation of the communication without a direct expression of an attitude. The tool (530) utilizes and maintains two components, including a dictionary (532) and a model (536). The dictionary (532) functions to mine data from the communication, including one or more keywords, and to identify an expression of relevance associated with the content. In one embodiment, the dictionary (532) is stored at a first memory location. Once the expression has been identified, it is quantified. More specifically, the model (536) quantifies the expression by statistically assessing attitude relevance. In one embodiment, the dictionary (532) generates one or more features for the model (536). The assessment generated by the model is stored in a second memory location. In the example shown herein, the first and second memory locations (552) and (562), respectively, are local to persistent storage (550), including data associated with both the dictionary (532) and the model (536). In one embodiment, the memory location may be local memory, such as memory (516). Accordingly, the dictionary (532) and model (536) are separately accessible tools employed for attitude detection.

The tools that are created and stored in the memory locations are utilized to assess attitude associated with a communication. More specifically, the attitude detection relates to potential attitude towards a target without evaluation or detection of a specific keyword in the communication. A classifier (570) is provided in communication with the dictionary (532) and the model (536). Specifically, the classifier (570) intercepts a communication emanating from a source, shown herein as one of the nodes (520), and functions to compare the communication to the model (536). Based on this comparison, the classifier (570) creates an attitude classification (574) for the source. Examples of the classification include, but are not limited to, relevant and irrelevant. The comparison enables the classifier (570) to convert an identity of the source (520) to an attitude classification (574). As such, the source (520), and associated communications of the source (520), may be considered and classified as relevant or irrelevant. The dictionary (532) may be static, or in one embodiment, the dictionary construction may be dynamic. The dynamic form of the dictionary may be updated on a periodic basis, updated based on new examples, or updated based on model-correction feedback. Regardless of the nature in which the dictionary is maintained, the employment of the dictionary in conjunction with the model supports detection of the attitude of the source before or without evaluation of a direct expression.

The dictionary (532) and the model (536) perform the computations that enable the classification. As shown and described in FIG. 1, the dictionary (532) separately computes positive features and negative features. More specifically, the dictionary (532) computes one or more text features from expression content identified as positive expression. The positive features are stored in the first memory location (552). Similarly, the dictionary computes one or more text features from expression content identified as negative expression. The negative features are stored in the second memory location (562). As one or more non-classified communications are received, the model (536) functions to compute the strength of the communication. The strength is based on a matching score of a keyword between content of the communication and any keyword(s) in the dictionary. For example, the dictionary may include keywords parsed from content identified as positive and associated those keywords with a positive expression, and employ similar techniques for negative expressions. In one embodiment, the specific keyword may not be present and the evaluation is conducted on a synonym of the keyword that is present in the dictionary. Similarly, in one embodiment, the model (536) evaluates a topic associated with the one or more identified keywords. For example, the keywords in the dictionary may be categorized into one or more topics, and the model (536) may conduct topic modeling. In one embodiment, the topic modeling may entail computations, such as probability value assessment, matching score(s) computed as a sum of all probability scores normalized by message length. Details of the score(s) and associated computations are shown and described in FIG. 4. Accordingly, the tools shown herein identify users who have a potential attitude towards a target, including attitude favorability, attitude persistence, and attitude resistance.

The system described above in FIG. 5 has been labeled with tools in the form of a dictionary (532), a model (536), and a classifier (570). The tools may be implemented in programmable hardware devices such as field programmable gate arrays, programmable array logic, programmable logic devices, or the like. The tools may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of the tools need not be physically located together, but may comprise disparate instructions stored in different locations which, when joined logically together, comprise the tools and achieve the stated purpose of the tool.

Indeed, executable code could be a single instruction, or many instructions, and may even be distributed over several different code segments, among different applications, and across several memory devices. Similarly, operational data may be identified and illustrated herein within the tool, and may be embodied in any suitable form and organized within any suitable type of data structure. The operational data may be collected as a single data set, or may be distributed over different locations including over different storage devices, and may exist, at least partially, as electronic signals on a system or network.

Furthermore, the described features, structures, or characteristics may be combined in any suitable manner in one or more embodiments. In the following description, numerous specific details are provided, such as examples of agents, to provide a thorough understanding of embodiments. One skilled in the relevant art will recognize, however, that the embodiment(s) can be practiced without one or more of the specific details, or with other methods, components, materials, etc. In other instances, well-known structures, materials, or operations are not shown or described in detail to avoid obscuring aspects of the embodiment(s).

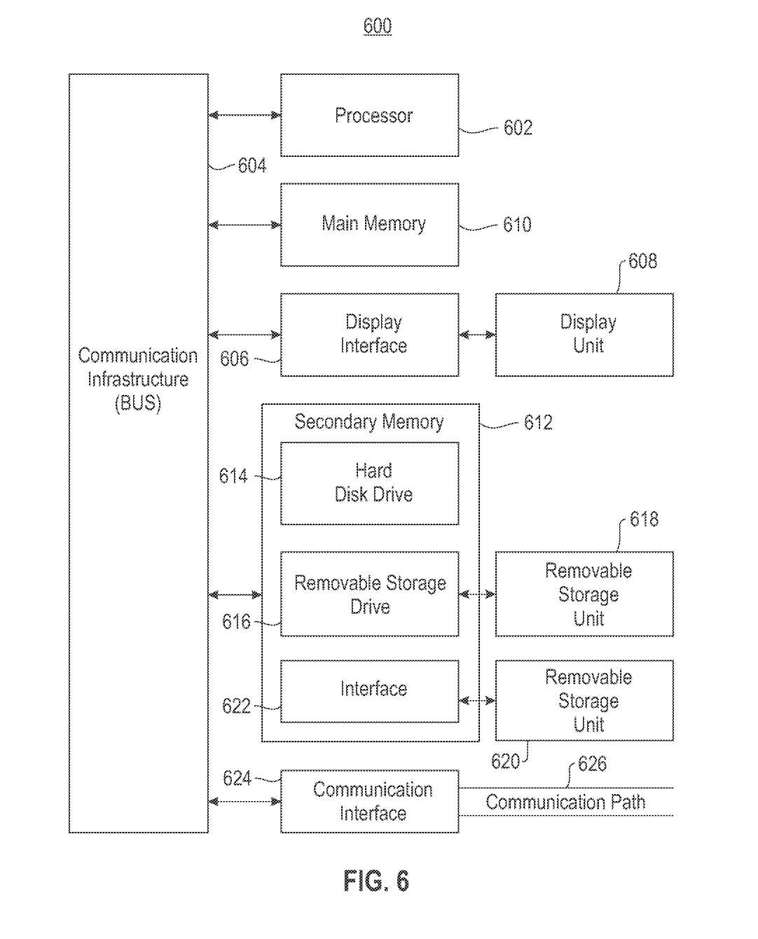

Referring now to the block diagram of FIG. 6, additional details are now described with respect to implementing an embodiment. The computer system includes one or more processors, such as a processor (602). The processor (602) is connected to a communication infrastructure (604) (e.g., a communications bus, cross-over bar, or network).

The computer system can include a display interface (606) that forwards graphics, text, and other data from the communication infrastructure (604) (or from a frame buffer not shown) for display on a display unit (608). The computer system also includes a main memory (610), preferably random access memory (RAM), and may also include a secondary memory (612). The secondary memory (612) may include, for example, a hard disk drive (614) and/or a removable storage drive (616), representing, for example, a floppy disk drive, a magnetic tape drive, or an optical disk drive. The removable storage drive (616) reads from and/or writes to a removable storage unit (618) in a manner well known to those having ordinary skill in the art. Removable storage unit (618) represents, for example, a floppy disk, a compact disc, a magnetic tape, or an optical disk, etc., which is read by and written to by removable storage drive (616).

In alternative embodiments, the secondary memory (612) may include other similar means for allowing computer programs or other instructions to be loaded into the computer system. Such means may include, for example, a removable storage unit (620) and an interface (622). Examples of such means may include a program package and package interface (such as that found in video game devices), a removable memory chip (such as an EPROM, or PROM) and associated socket, and other removable storage units (620) and interfaces (622) which allow software and data to be transferred from the removable storage unit (620) to the computer system.

The computer system may also include a communications interface (624). Communications interface (624) allows software and data to be transferred between the computer system and external devices. Examples of communications interface (624) may include a modem, a network interface (such as an Ethernet card), a communications port, or a PCMCIA slot and card, etc. Software and data transferred via communications interface (624) is in the form of signals which may be, for example, electronic, electromagnetic, optical, or other signals capable of being received by communications interface (624). These signals are provided to communications interface (624) via a communications path (i.e., channel) (626). This communications path (626) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (610) and secondary memory (612), removable storage drive (616), and a hard disk installed in hard disk drive (614).

Computer programs (also called computer control logic) are stored in main memory (610) and/or secondary memory (612). Computer programs may also be received via a communication interface (624). Such computer programs, when run, enable the computer system to perform the features of the present embodiment(s) as discussed herein. In particular, the computer programs, when run, enable the processor (602) to perform the features of the computer system. Accordingly, such computer programs represent controllers of the computer system.

The present embodiment(s) may be a system, a method, and/or a computer program product. The computer program product may include a computer readable storage medium (or media) having computer readable program instructions thereon for causing a processor to carry out aspects of the present embodiment(s).

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiment(s).

Aspects of the present embodiment(s) are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the functions/acts specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions and/or acts or carry out combinations of special purpose hardware and computer instructions.

The terminology used herein is for the purpose of describing particular embodiments only and is not intended to be limiting. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the form disclosed. Many modifications and variations will be apparent to those of ordinary skill in the art without departing from the scope and spirit. The embodiment was chosen and described in order to best explain the principles and the practical application, and to enable others of ordinary skill in the art to understand the various embodiments with various modifications as are suited to the particular use contemplated. Accordingly, the implementation builds both a relevance dictionary and a statistical model of attitude relevance, and employs these items to classify a user as either relevant or non-relevant with respect to attitude towards a target.

It will be appreciated that, although specific embodiments have been described herein for purposes of illustration, various modifications may be made without departing from the spirit and scope. In particular, the statistical model building may include regression and/or a support vector machine (SVM). In addition to classification of the user as relevant or non-relevant for a specific target, the classification may also output a probability so that test users can be ranked in terms of their relevance. Furthermore, the attitude detection and assessment may be expanded to identify different attitude characteristics, including but not limited to attitude favorability, attitude persistent, and attitude resistance. Accordingly, the scope of protection is limited only by the following claims and their equivalents.

1. (canceled)

2. (canceled)

3. (canceled)

4. (canceled)

5. (canceled)

6. (canceled)

7. (canceled)

8. (canceled)

9. A computer program product comprising a computer readable storage medium device having computer readable program code embodied therewith, the program code when executed on a processor causes the computer to:
construct an attitude dictionary for each identified target, including mining keywords from content of social media posts, the dictionary identifying an expression of relevance;
store the dictionary at a first memory location;
build a statistical model of attitude relevance towards each target, wherein the dictionary generates features for the model;
store the model at a second memory location; and
prior to receipt of a direct expression to a target, comparing a communication from a source to the model and create an attitude classification for the source, wherein the comparison converts an identity of the source to the attitude classification.

10. The computer program product of claim 9, further comprising program code to dynamically update the dictionary based on new target identification.

11. The computer program product of claim 9, further comprising program code to compute one or more text features from positive expression content and store the positive features, and compute one or more text features from negative expression content and store the negative features.

12. The computer program product of claim 11, further comprising program code to compute strength of the communication associated with the source based on a keyword matching score between message content and one or more keywords in the dictionary.

13. The computer program product of claim 12, further comprising program code to model one or more topics of identified keywords and associate each keyword in the dictionary with a probability value obtained from topic modeling, and compute a matching score for the communication as a sum of all probability scores normalized by message length.

14. The computer program product of claim 13, further comprising program code to categorize the dictionary by one or more topics and identify one or more keywords for each topic, and search for a match with one of the identified keywords from each topic, including averaging the probability value of the matched keyword.

15. The computer program product of claim 14, further comprising program code to calculate a co-occurrence score, including counting a quantity of co-occurrence of keywords in a message and normalize the quantity by pairs of keywords in the message.

16. The computer program product of claim 14, further comprising program code to compute a confidence of co-occurrence of keywords in a message for each pair of keywords in a topic.

17. A computer system comprising:
a processing unit operatively coupled to memory;
a tool in communication with the processing unit to detect attitude associated with a communication, including:
a dictionary to mine or more keywords from content of social media, and to identify an expression of relevance;
a first memory location to store the dictionary;
a model to statistically assess attitude relevance, wherein the dictionary generates one or more features for the model;
a second dictionary to store the model;
a classifier to compare a communication from a source to the model and to create an attitude classification for the source, wherein the comparison converts an identity of the source to the attitude classification.

18. The system of claim 17, further comprising the dictionary to compute one or more text features from positive expression content and to store the positive features in the first memory location, and to compute one or more text features from negative expression content and to store the negative features in the second memory location.

19. The system of claim 18, further comprising the model to compute strength of a communication based on a keyword matching score between communication content and one or more keywords in the dictionary.

20. The system of claim 19, further comprising the model to evaluate a topic of the one or more identified keywords, and to associate each keyword in the dictionary with a probability value obtained from topic modeling, and further comprising the model to compute a matching score for the communication as a sum of all probability scores normalized by message length.
